(19) United States
(12) Patent Application Publication
(10) Pub. No.: US 2004/0090409 A1
(43) Pub. Date: May 13, 2004

(54) Gamma correction voltage generation device, and gamma correction device and display device using the same

(75) Inventors: Kenichi Nakata, Kyoto-shi (JP); Mikiya Doi, Kyoto-shi (JP); Koichi Inoue, Kyoto-shi (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: Rohm Co., Ltd.

(21) Appl. No.: 10/702,657

(22) Filed: Nov. 7, 2003

(30) Foreign Application Priority Data
Nov. 11, 2002 (JP) 2002-326266

(51) Int. Cl. G09G 3/36

(52) U.S. Cl. 345/89

(57) ABSTRACT

A gamma correction voltage generation device relating to the invention has a plurality of sets, each comprising a data holding section for holding digital data inputted thereto, a digital-to-analog converter for converting the digital data held in the data holding section to an analog voltage, and a buffer for amplifying a capacity of current of the analog voltage and outputting the analog voltage, wherein the analog voltages are outputted from the buffers as gamma correction voltages. By this configuration, it becomes possible to perform a process of adjustments on the gamma correction voltages easily and efficiently.

### BACKGROUND OF THE INVENTION

1. Field of the Invention

The present invention relates to a gamma correction voltage generation device for generating gamma correction voltages for a liquid crystal display (hereinafter an LCD), and a gamma correction device and a display device using the same.

2. Description of the Prior Art

In recent years, a liquid crystal display device using and comprising an LCD has been widely and commonly used as an information display device for electronic appliances requiring a reduction in size or a miniaturization, because it is thinner and consumes less power. Here, as shown in FIG. 4A, there exists a nonlinear correlation (hereinafter the gamma characteristic) between voltage applied to the LCD and a light transmissivity. For this reason, it is necessary, as shown in FIG. 4B, to perform a level conversion (hereinafter a gamma correction) in accordance with a voltage level of input signals fed to the LCD.

Consequently, a conventional liquid crystal display device is configured in such a way that input voltages V1 to Vn are compensated for in accordance with the gamma characteristic of the LCD and applied thereto as output voltages V1′ to Vn′ so that linear light transmissivities T1 to Tn are obtained by the input voltages V1 to Vn each of which is spaced in constant increments. A generating means for generating the output voltages (hereinafter the gamma correction voltages) V1′ to Vn′ to be used in a process of the gamma correction for the LCD usually includes a resistance ladder for dividing a predetermined voltage into a plurality of voltages (refer to, for example, Japanese Patent Application Laid-Open No. H10-108040).

It is certainly possible to optimize the gamma characteristic, and thereby images are displayed satisfactorily on the LCD, if the liquid crystal display device configured as mentioned above is used.

However, the liquid crystal display device configured as mentioned above requires repetitions of complicated and inefficient works involving changing scores of external resistance elements that form the resistance ladder and checking an image shown on the LCD in order to perform fine adjustments on the output voltages V1′ to Vn′ so that the output voltages conform to the gamma characteristic of the LCD. Accordingly, it is impossible to perform the fine adjustments while checking on the display in real time. This means that because an extended period of time is required to perform the adjustments on the liquid crystal display configured as described above, it is difficult to cope with changes in the gamma characteristic swiftly for such an LCD designed for a high definition image or a larger screen. Furthermore, the scores of external resistance elements as a means for adjusting the gamma characteristic occupy a wide area on a substrate and prevent a size of the device from being miniaturized.

As a conventional technology, a gamma correction device having a configuration different from the one described before is disclosed or suggested. The gamma correction device, by approximating a gamma characteristic curve of an LCD with a plurality of straight lines, discriminates from the strait lines a line corresponding to a level of input signals fed to the LCD and performs an input/output level conversion accordingly (refer to, for example, Japanese Patent Application Laid-Open No. H11-32237). The gamma correction device configured in this way, however, requires a discriminator circuit for finding a corresponding line and various arithmetic circuits, and this causes the device to become complicated and large in size.

Disclosed or suggested as another example of the conventional technology is a gamma correction device that performs an input/output level conversion based on a conversion table memorizing an output level corresponding to an input level (refer to, for example, U.S. Pat. No. 5,796,384). The gamma correction device configured in this way, however, requires creating the conversion table for each characteristic of an LCD, and this causes a memory for storing the conversion table to occupy an extensive area on a substrate.

### SUMMARY OF THE INVENTION

An object of the present invention is, in light of the above-mentioned shortcomings, to provide a gamma correction voltage generation device, and a gamma correction device and a display device using the same, all of which enable an easy and efficient process for adjusting the gamma correction voltages.

To achieve the above object, according to one aspect of the present invention, a gamma correction voltage generation device relating to the invention has a plurality of sets, each comprising a data holding section for holding digital data inputted thereto, a digital-to-analog converter for converting the digital data held in the data holding section to an analog voltage, and a buffer for amplifying a capacity of current of the analog voltage and outputting the analog voltage, wherein the analog voltages are outputted from the buffers as gamma correction voltages.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a block diagram showing the liquid crystal display device of the first embodiment of the invention;

FIG. 2 is a block diagram showing the liquid crystal display device of the second embodiment of the invention;

FIG. 3 is a block diagram showing the liquid crystal display device of the third embodiment of the invention; and

FIG. 4A and FIG. 4B are diagrams for explaining the gamma correction.

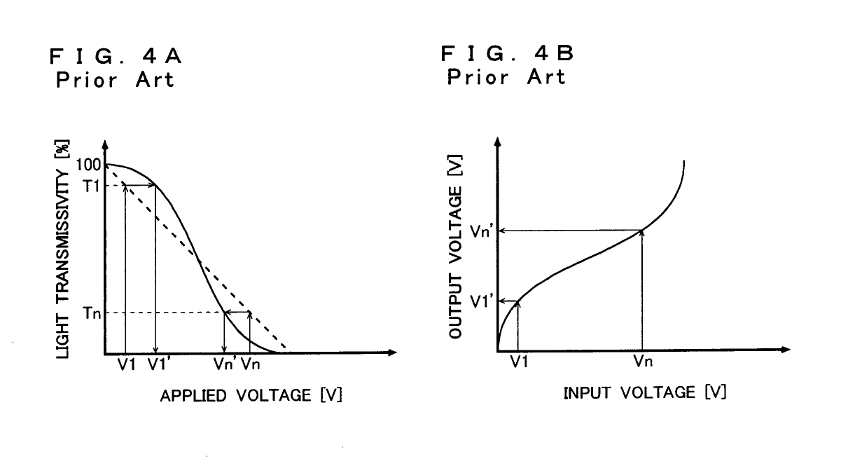

### DESCRIPTION OF THE PREFERRED EMBODIMENTS

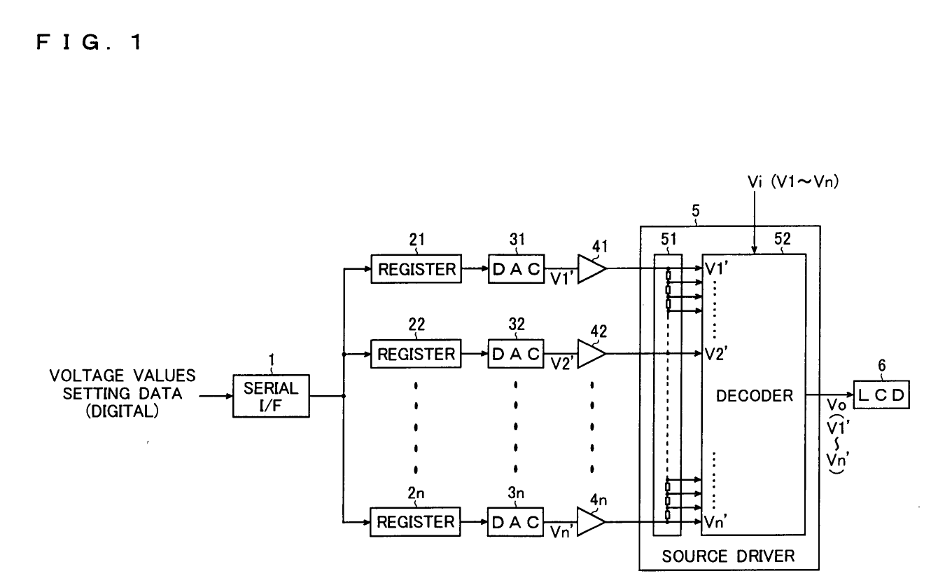

First, a liquid crystal display device of a first embodiment of the invention will be described in details with reference to FIG. 1. FIG. 1 is a block diagram showing the liquid crystal display device of the first embodiment of the invention. As shown in FIG. 1, the liquid crystal display device of the first embodiment comprises a serial interface 1 (hereinafter the serial I/F) for distributing n sets of digital data that are inputted serially thereto among registers 21 to 2n, the registers 21 to 2n for holding the inputted digital data, digital-to-analog converters 31 to 3n (hereinafter the DACs 31 to 3n) for converting the digital data held by the registers 21 to 2n to analog voltages V1′ to Vn′, buffers 41 to 4n for amplifying a capacity of current of the analog voltages V1 to V1′ and outputting the analog voltages, a source driver 5 for converting an input signal Vi to an output signal Vo and outputting, and a liquid crystal display 6 (hereinafter the LCD 6) having, as a pixel, a liquid crystal element that changes the light transmissivity thereof in accordance with voltage being applied.

In the liquid crystal display device that is configured as described, the source driver 5 comprises a resistance ladder 51 for equally dividing the analog voltages (the gamma correction voltages) V1′ to Vn′ that are fed out from the buffers 41 to 4n and generating intermediate voltages between two adjoining voltages among the analog voltages V1′ to Vn′, and a decoder 52 for selecting and outputting the output voltage Vo (the gamma correction voltage V1′ to Vn′ or the intermediate voltages therebetween) according to the input voltage Vi (the voltages V1 to Vn).

According to the liquid crystal display device as described above, it is possible to rewrite the digital data held by the registers 21 to 2n (i.e., the digital data inputted to the serial I/F 1) and, at the same time, check an image on the LCD 6 in real time. When the adjustments are completed, the digital data stored in the registers 21 to 2n are memorized in an unillustrated non-volatile memory device and, thereafter, the display is operated using the above-mentioned digital data. Consequently, this makes it possible to conduct adjustments on the gamma correction voltages V1′ to Vn′ easily and efficiently, and thereby cope swiftly with changes in the gamma characteristic of the LCD 6 even if it is designed for a high definition image or a larger screen. It is also possible to realize a reduction in size of the device, because such scores of external resistance elements as a means for adjusting the gamma characteristic will be no longer necessary when compared with the conventional configuration.

Additionally, in such a configuration as the liquid crystal display device of the embodiment in which the digital data to be stored in the registers 21 to 2n are entered serially, it is possible, by reducing external wires, to prevent a size of the device from being unnecessarily increased.

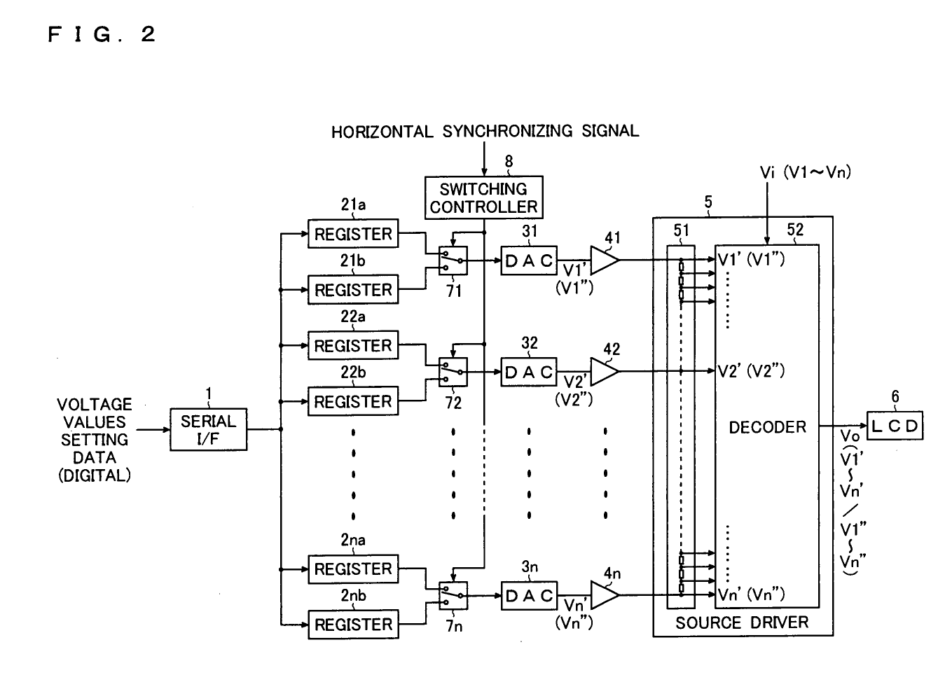

Next, a liquid crystal display device of a second embodiment of the invention will be described in details with reference to FIG. 2. FIG. 2 is a block diagram showing the liquid crystal display device of the second embodiment of the invention. As shown in FIG. 2, the liquid crystal display device of the second embodiment is configured in such a manner almost similar to the first embodiment (refer to FIG. 1). Therefore, such portions as are found also in the first embodiment are identified with the same reference numerals as found in FIG. 1, descriptions thereof are not repeated, and descriptions hereunder are centered on features specific to the second embodiment.

As shown in the illustration, a liquid crystal display device has, in a stage before the DACs 31 to 31n, sets of the registers 21a and 21b to the registers 2na and 2nb for holding n sets×m patterns of digital data (where n≧2 and m≧2, and an example in which m=2 is shown in the embodiment) that are inputted, selectors 71 to 7n for selecting one from among the sets of digital data each of which is held by each set of the registers 21a and 21b to the registers 2na and 2nb, and a switching controller 8 for controlling a switching operation of each of the selectors 71 to 7n.

In this way, m patterns of digital data (in this embodiment, two patterns including pattern a and pattern b) to be inputted to the DACs 31 to 3n are held by the registers 21a to 2na and the registers 21b to 21nb respectively, and one of the patterns a and b is selected as required to generate the analog voltages V1′ to Vn′ or V1″ to Vn″ so that the gamma correction according to user's requirement can be achieved.

The switching controller 8 is configured such that the selectors 71 to 7n are controlled in accordance with scanlines of the LCD 6 for which the gamma is corrected. For example, the pattern a is selected for odd-numbered scanlines and the pattern b is selected for even-numbered scanlines. According to this configuration, it is possible to enhance the image quality displayed on the LCD 6.

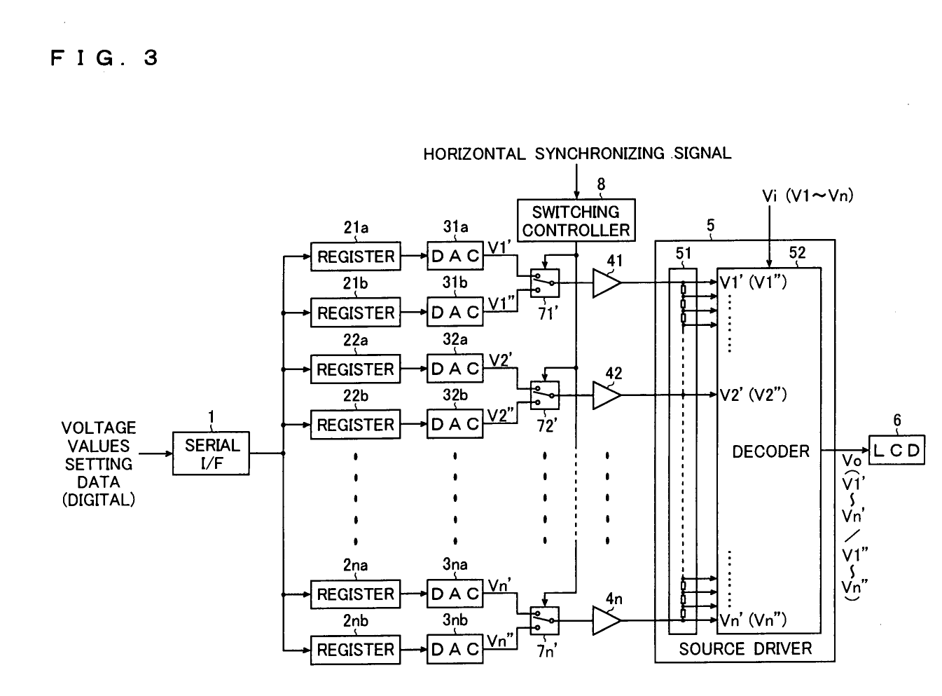

Next, a liquid crystal display device of a third embodiment of the invention will be described in details with reference to FIG. 3. FIG. 3 is a block diagram showing the liquid crystal display device of the third embodiment of the invention. As shown in FIG. 3, the liquid crystal display device of the third embodiment is configured in such a manner almost similar to the second embodiment (refer to FIG. 2). Therefore, such portions as are found also in the second embodiment are identified with the same reference numerals as found in FIG. 2, descriptions thereof are not repeated, and descriptions hereunder are centered on features specific to the third embodiment.

As shown in the illustration, a liquid crystal display device having, in a stage after sets of the registers 21a and 21b to the registers 2na and 2nb that hold n sets×m patterns of digital data (where n≧2 and m≧2, and an example in which m=2 is shown in the embodiment) that are inputted, sets of the DACs 31a and 31b to the DACs 3na and 3nb, is configured such that, by way of selectors 71′ to 7n′ arranged thereafter, one pattern of the analog voltages V1′ to Vn′ or the analog voltages V1″ to Vn″ is selected and outputted to the buffers 41 to 4n.

In this way, a plurality of patterns of analog voltages, two patterns in this embodiment including the pattern a for V1′ to Vn′ and the pattern b for V1″ to Vn″ to be inputted to the buffers 41 to 4n, are generated. Therefore, by configuring the device in such a way that one pattern is selected for use as required, it is possible to use one set of analog voltages for a different purpose while the other set of analog voltages is inputted to the buffers 41 to 4n.

Moreover, in each embodiment described before, it is possible to easily memorize the corrected values without a memory device being separately arranged, if the registers are provided as non-volatile memories. Furthermore, in these embodiments, any types of DAC can be used.

As previously mentioned, a gamma correction voltage generation device relating to the invention has n sets (where n≧2), each comprising, a data holding section for holding digital data inputted thereto, a digital-to-analog converter for converting the digital data held in the data holding section to an analog voltage, and a buffer for amplifying a capacity of current of the analog voltage and outputting the analog voltage, wherein the analog voltages are outputted from the buffers as gamma correction voltages. This configuration makes it possible to check an image on the liquid crystal display in real time while rewriting the digital data held by each data holding portion. As a result of this, it becomes possible to swiftly cope with changes in the gamma characteristic of the liquid crystal display designed for a high definition image or a larger screen, because the adjustment process for the gamma correction voltages is made easier and performed efficiently. At the same time, it is also possible to achieve a reduction in device size, because the scores of external resistance elements as a means for adjusting the gamma characteristic become no longer necessary.

Furthermore, a gamma correction voltage generation device relating to the invention has n sets (where n≧2), each comprising, m data holding sections (where m≧2), each for holding each of m patterns of digital data inputted thereto, a selector for selecting and outputting digital data from among the digital data held by the data holding sections, a digital-to-analog converter for converting the set of digital data selected by the selector to an analog voltage, and a buffer for amplifying a capacity of current of the analog voltage and outputting the analog voltage, wherein the analog voltages are outputted from the buffers as gamma correction voltages. By this configuration, it is possible, in addition to previously mentioned advantages, to perform the gamma correction tailored to users' specific needs.

Furthermore, a gamma correction voltage generation device relating to the invention has n sets (where n≧2), each comprising, m data holding sections (where m≧2), each for holding each of m patterns of digital data inputted thereto, m digital-to-analog converters, each for converting the digital data held by each of the data holding sections to an analog voltage, a selector for selecting and outputting an analog voltage from among the analog voltages generated by the digital-to-analog converters, and a buffer for amplifying a capacity of current of the analog voltage selected by the selector and outputting the analog voltage, wherein the analog voltages are outputted from the buffers as gamma correction voltages. By this configuration, it is possible, in addition to previously mentioned advantages, to use one pattern of the analog voltages for different purpose while the other patter of the analog voltages is inputted to the buffers.

Moreover, it is desirable that the gamma correction voltage generation device configured as above be configured so as to have a switching controller for controlling a switching operation of each of the selectors in accordance with scanlines of a liquid crystal display for which a gamma correction is performed. In such a configuration, it is possible to enhance the image quality on the liquid crystal display.

Moreover, it is desirable that the gamma correction voltage generation device configured as above be configured so as to have a serial interface for distributing the digital data comprising n sets or n sets×m patterns inputted thereto serially among all of the data holding sections. In such a configuration, it is possible to reduce the number of external wires and prevent the device from being unnecessarily increased in size.

Furthermore, it is desirable that a gamma correction device relating to the invention comprise a gamma correction voltage generation device for generating a plurality of gamma correction voltages, a resistance ladder for generating intermediate voltages between two adjoining voltages among the gamma correction voltages, and a decoder for selecting and outputting a voltage from among the gamma correction voltages and the intermediate voltages in accordance with a voltage level of an input signal. By this configuration, it is possible to realize such a gamma correction device by which the adjustment process on the gamma correction voltages is made easier and performed efficiently.

Furthermore, it is desirable that a display device relating to the invention comprise, as a means for correcting the gamma on a liquid crystal display, the gamma correction device configured in a way as described above. By this configuration, it is possible to realize such a display device that allows a process of adjustments of the gamma correction voltages to be made easier and efficiently.

What is claimed is:

1. A gamma correction voltage generation device having n sets (where n≧2), each comprising:
a data holding section for holding digital data inputted thereto;
a digital-to-analog converter for converting the digital data held in the data holding section to an analog voltage; and
a buffer for amplifying a capacity of current of the analog voltage and outputting the analog voltage,
wherein the analog voltages are outputted from the buffers as gamma correction voltages.

2. A gamma correction voltage generation device as claimed in claim 1, further comprising,
a serial interface section for distributing among the data holding sections n sets of the digital data inputted thereto serially.

3. A gamma correction voltage generation device having n sets (where n≧2), each comprising:
m data holding sections (where m≧2), each for holding each of m patterns of digital data inputted thereto;
a selector for selecting and outputting digital data from among the digital data held by the data holding sections;
a digital-to-analog converter for converting the set of digital data selected by the selector to an analog voltage; and
a buffer for amplifying a capacity of current of the analog voltage and outputting the analog voltage,
wherein the analog voltages are outputted from the buffers as gamma correction voltages.

4. A gamma correction voltage generation device as claimed in claim 3, further comprising,
a switching controller for controlling a switching operation of each of the selectors in accordance with scanlines of a liquid crystal display for which a gamma correction is performed.

5. A gamma correction voltage generation device as claimed in claim 3, further comprising,
a serial interface for distributing the digital data comprising n sets×m patterns inputted thereto serially among all of the data holding sections.

6. A gamma correction voltage generation device having n sets (where n≧2), each comprising:
m data holding sections (where m≧2), each for holding each of m patterns of digital data inputted thereto;
m digital-to-analog converters, each for converting the digital data held by each of the data holding sections to an analog voltage;
a selector for selecting and outputting an analog voltage from among the analog voltages generated by the digital-to-analog converters; and
a buffer for amplifying a capacity of current of the analog voltage selected by the selector and outputting the analog voltage,
wherein the analog voltages are outputted from the buffers as gamma correction voltages.

7. A gamma correction voltage generation device as claimed in claim 6, further comprising,
a switching controller for controlling a switching operation of each of the selectors in accordance with scanlines of a liquid crystal display for which a gamma correction is performed.

8. A gamma correction voltage generation device as claimed in claim 3, further comprising,
a serial interface for distributing the digital data comprising n sets×m patterns inputted thereto serially among all of the data holding sections.

9. A gamma correction device comprising:
a gamma correction voltage generation device for generating a plurality of gamma correction voltages;
a resistance ladder for generating intermediate voltages between two adjoining voltages among the gamma correction voltages; and
a decoder for selecting and outputting a voltage from among the gamma correction voltages and the intermediate voltages in accordance with a voltage level of an input signal,
wherein the gamma correction voltage generation device has a plurality of sets, each comprising:
a data holding section for holding digital data inputted thereto;
a digital-to-analog converter for converting the digital data held in the data holding section to an analog voltage; and
a buffer for amplifying a capacity of current of the analog voltage and outputting the analog voltage,
wherein the analog voltages are outputted from the buffers as gamma correction voltages.

10. A display device comprising:
a liquid crystal display comprising, as a pixel, a liquid crystal element that changes a light transmissivity thereof in accordance with a level of voltage being applied;
a gamma correction voltage generation device for generating a plurality of gamma correction voltages;
a resistance ladder for generating intermediate voltages between two adjoining voltages among the gamma correction voltages; and
a decoder for selecting a voltage from among the gamma correction voltages and the intermediate voltages in accordance with a voltage level of an input signal and outputting to the liquid crystal display,
wherein the gamma correction voltage generation device has a plurality of sets, each comprising:
a data holding section for holding digital data inputted thereto;
a digital-to-analog converter for converting the digital data held in the data holding section to an analog voltage; and
a buffer for amplifying a capacity of current of the analog voltage and outputting the analog voltage,
wherein the analog voltages are outputted from the buffers as gamma correction voltages.
